(19) United States
(12) Patent Application Publication
(10) Pub. No.: US 2004/0103990 A1
(43) Pub. Date: Jun. 3, 2004

(54) Glue metering in a paste unit

(76) Inventors: Ruediger Duwendag, Lengerich (DE); Guido Kerres, Muenster (DE)

Correspondence Address: JACOBSON HOLMAN PLLC, 400 SEVENTH STREET N.W., SUITE 600, WASHINGTON, DC, 20004, US

(21) Appl. No.: 10/721,890

(22) Filed: Nov. 26, 2003

(30) Foreign Application Priority Data
Nov. 27, 2002 (DE) 102 55 484.6

(51) Int. Cl. B65C 11/04

(52) U.S. Cl. 156/356; 156/578

(57) ABSTRACT

The invention relates to a paste unit for a bottom guide device for star seal bottom bags, which are formed from tube sections, for gluing of bottom warps or star seal bottom bags, and has at least the following characteristics:

a glue reservoir (4), and/or a glue source, a metering roller (3), which is connected with the glue reservoir (4), a glue application roller (2), which may be connected to the glue reservoir (4) or the glue source, and a making roller (1), which is connected to the glue application roller (2), and which transfers glue (7) from this roller (2) to the bottom warps or the star seal bottoms. Drive means are assigned to the above listed rollers (1, 2, 3). The paste unit of the bottom guide device described above is characterized in that the circumference speed of the glue application roller (2) and of the making roller (1) can be adjusted independently of one another.

The invention relates to a paste unit for a bottom guide device for star seal bottom bags according to the generic term of claim 1

Such paste units are known, for example; from patent specification DE 195 32 582. A paste unit of the known type consists of at least one metering roller and one glue application roller, which are connected to a glue reservoir that is embodied as a housing. The metering roller has the same direction of rotation as the glue application roller so that, in this function, it may also be referred to as a sealing roller. The glue absorbed by the glue application roller is removed by the printing roller or the making roller, and transferred by the same to the workpiece to be glued. The metering roller and the glue application roller are driven by means of a mutual toothed belt, which is set into motion by a toothed belt disk.

The amount of glue to be transferred is determined by the gap predetermined by the distance between the metering roller and the glue application roller. For example, if no glue is to be transferred, the gap between the two rollers is closed. The larger the gap is chosen, the more glue is transferred to the making roller and from the same to the workpiece to be glued.

The setting of the distance occurs, for example, from a piston cylinder unit by means of a mechanical leverage.

Such engineering mechanics, however, have the disadvantage that they are costly and prone to contamination, which may be caused by the glue. Furthermore, the changes of the glue application amounts cannot be adjusted precisely enough.

Therefore, the task of the invention is to recommend a device that enables the metering of the glue amount to be applied without using any engineering mechanics for the distance control, and that also possesses a high degree of sensitivity in controlling the glue amount control.

According to the invention, this task is solved by means of the features of the characteristic part of claim 1. Accordingly, the circumference speeds of the glue application roller and of the making roller or the printing roller can be adjusted independently of one another. In this manner, the ratio of the circumference speeds of both rollers can be selected freely.

Tests have shown that a larger amount of glue can be transferred from the glue application roller to the making roller, if the circumference speed of the glue application roller is increased. Analogously, the circumference speed of the glue application roller is reduced, if a smaller amount of glue is to be applied.

It is beneficial to also adjust the circumference speed of the metering roller independently of the two other rollers, because this has a sealing effect, as described in the introduction. This sealing effect can be influenced by means of the suitable selection of the circumference speed.

It is particularly beneficial, if the direction of rotation of the sealing roller can additionally be reversed.

In a particularly preferred embodiment of the invention, at least one of the three rollers assigned to the paste unit has its own drive.

It is beneficial that at least one of the said rollers has its own drive motor, which is supplied with current by a power electronic power source.

Iri an especially preferred embodiment of the invention, the said drive means are controlled via a control device. The control device has a data processor, which, depending on the desired glue application amount, or on the desired change of glue application amount, adjusts the circumference speeds of the rollers involved in the glue transport, and aligns them with one another.

It is of particular advantage if the control device starts with a pre-adjusted circumference speed of the making roller in the adjustment and the alignment of the circumference speeds of the rollers.

In this case, the control device may then, for example by means of multiplication with a pre-adjusted ratio between the circumference speeds, control the speed of at least one additional roller.

The invention further includes a method for controlling the glue amount of a paste unit of a bottom guide device for star seal bottom bags, whereby the paste unit glues bottom warps, valve beams, or star seal bottoms, and has at least one glue reservoir and/or a glue source, a metering roller that is connected to the glue reservoir, a glue application roller, which may be connected to the glue reservoir or the glue source, a making roller, which takes off glue from the glue application roller and feeds it to the workpieces to be glued and whereby drive means are assigned to the said rollers. The method according to the invention has the characteristic that the ratio of the circumference speeds of the glue application roller and the making roller is varied for controlling the glue application amount.

Additional embodiment examples of the invention are included in the subject description and the claims.

The individual figures show:

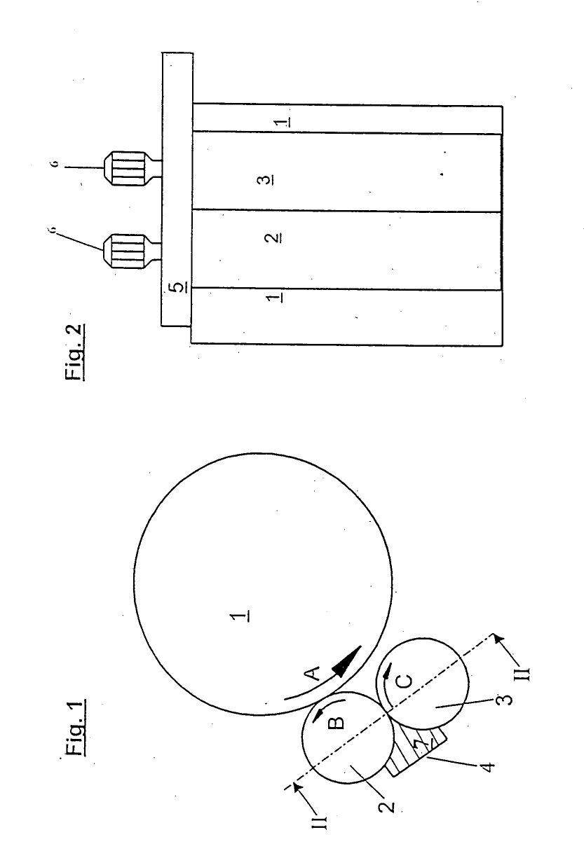

FIG. 1 Top view of a paste unit according to the invention

FIG. 2 Side view of the paste unit according to section line 11-11 in FIG. 1

FIG. 1 shows a top view of a paste unit according to the invention. The glue 7 is located in a glue body 4, and is taken off by the glue application roller 2 and transferred to the making roller 1. The metering roller 3 ensures that the glue 7 is not discharged unintentionally from the glue body 4. The direction of rotation C of the metering roller 3 can be reversed, while it generally makes no sense to change the directions of rotation A and B of the making roller 1, or the glue application roller 2, respectively.

FIG. 2 shows the section 11-11 in FIG. 1. The glue application roller 2 and the metering roller 3 are supported in a base plate 5 suspended on one end. Two electric motors 6 are attached above the base plate 5, the drive shafts of which activate the axes of each of the two said rollers. The base plate 5, like the making roller 1, is attached in the machine rack in a manner which is not illustrated. The circumference speeds of the rollers 2, 3 can be adjusted according to the —specifications of the glue transfer and glue application by means of the electric motors 6, which are supplied with current by means of power controllers, also not illustrated, that can be activated via a control unit.

Reference Symbol List

| | |
|---|---|
| 1 | Making roller |
| 2 | Glue application roller |
| 3 | Metering roller |
| 4 | Glue body |
| 5 | Base plate |
| 6 | Electric motor |
| 7 | Glue |
| 8 | |
| 9 | |
| A | Direction of rotation of the making roller 1 |
| B | Direction of rotation of the glue application roller 2 |
| C | Direction of rotation of the metering roller 3 |

1. Paste unit for a bottom guide device for star seal bottom bags, which are formed from tube sections, for gluing of bottom warps or star seal bottom bags, and has at least the following characteristics:
a glue reservoir (4), and/or a glue source
a metering roller (3), which is connected with the glue reservoir (4)
a glue application roller (2), which may be connected to the glue reservoir (4) or the glue source,
a making roller (1), which is connected to the glue application roller (2), and which transfers glue (7) from this roller (2) to the bottom warps or the star seal bottoms,
whereby drive means are assigned to the above listed rollers (1, 2, 3),
characterized in that
the circumference speed of the glue application roller (2) and of the making roller (1) can be adjusted independently of one another.

2. Paste unit according to claim 1,
characterized in that
the circumference speed of the metering roller (3) can also be adjusted independently of the other two rollers (1, 2).

3. Paste unit according to claim 2,
characterized in that
the direction of rotation (C) the metering roller (3) can be reversed.

4. Paste unit according to one of the previous claims,
characterized in that
at least one of the previously stated rollers (1, 2, 3) has its own drive motor (6).

5. Paste unit according to one of the previous claims,
characterized in that
at least one of the previously stated rollers (1, 2, 3) has its own drive motor (6), which is supplied with current by a power electronic power controller—such as a frequency converter.

6. Paste unit according to one of the previous claims,
characterized in that
the drive means (6) are activated by a control device,
which has a data processor, which, depending on the
glue application amounts, or
changes of glue application amounts
desired by the machine operator, adjusts the circumference speed of the rollers (1, 2, 3) involved in the glue transport, and aligns them to one another.

7. Paste unit according to claim 6,
characterized in that
the control device bases the adjustment and alignment of the circumference speed of the rollers (1, 2, 3) on the circumference speed of the making roller (1).

8. Method for controlling the glue amount for a paste unit of a bottom guide device for star seal bottom bags,
whereby the paste unit glues bottom warps or star seal bottoms, and has at least the following characteristics:
one glue reservoir (4), and/or a glue source
a metering roller (3) that is connected to the glue reservoir (4)
a glue application roller (2), which may be connected to the glue reservoir (4) or the glue source,
a making roller (1), which is connected to the glue application roller (2), and which transfers glue from this roller (2) to the bottom warps or to the star seal bottoms
whereby drive means (6) are assigned to the above stated rollers (1, 2, 3),
characterized in that
the ratio of the circumference speeds of the glue application roller (2) and the making roller (3) is varied for controlling the glue application amount.
